(19) United States
(12) Patent Application Publication
(10) Pub. No.: US 2012/0269057 A1
(43) Pub. Date: Oct. 25, 2012

(54) ACTIVE/STANDBY SWITCHING METHOD SYSTEM CONTROL UNIT AND COMMUNICATION SYSTEM

(75) Inventors: Hu ZHAO, Hangzhou (CN); Yonghe Liu, Shenzhen (CN); Yuan Sun, Xi' an (CN); Wei Wang, Hangzhou (CN)

(73) Assignee: HUAWEI TECHNOLOGIES CO., LTD.

(21) Appl. No.: 13/453,591

(22) Filed: Apr. 23, 2012

Related U.S. Application Data
(63) Continuation of application No. PCT/CN2011/073277, filed on Apr. 25, 2011.

(51) Int. Cl. H04L 12/26; H04L 12/24

(52) U.S. Cl. 370/228; 370/248

(57) ABSTRACT

The present invention discloses an active/standby switching method,which includes: sending, by a first system control unit, a detection packet to a peer network element according to a set detection cycle; when the first system control unit receives an active/standby switching instruction, stopping sending the detection packet, so that transmission link switching is triggered when the first system control unit stops sending the detection packet in a set timeout period, and simultaneously starting, by the first system control unit, a switching timer; and when it is detects that a value of the switching timer reaches a switching timing value, performing a reset operation to complete active/standby switching, where the switching timing value is greater than the timeout period. Therefore, in the situation that active/standby switching is performed, a packet loss of a service data packet is reduced, and service continuity and reliability are ensured.

### CROSS-REFERENCE TO RELATED APPLICATIONS

This application is a continuation of International Application No. PCT/CN2011/073277, filed on Apr. 25, 2011, which is hereby incorporated by reference in its entirety.

### FIELD OF THE INVENTION

The present invention relates to communications technologies, and in particular, to an active/standby switching method, a system control unit, and a communication system.

### BACKGROUND OF THE INVENTION

Micro telecommunications computing architecture (Micro Telecommunications Computing Architecture, mTCA for short) is an architecture commonly used in hardware implementation in the field of communications. Generally, a system control unit (System Control Unit, SCU for short) is disposed on a backplane, and various service boards, for example, a general processing unit (General Processing Unit, GPU for short), a circuit interface unit (Circuit Interface Unit, CIU for short), an operation & maintenance unit (Operation & Maintenance Unit, OMU for short) and a data processing unit (Data Processing Unit, DPU for short), are connected through the SCU. The SCU and the various service boards form a system for implementing a particular service process function. The SCU implements data forwarding between the service boards, and controls a basic operation of an entire system, for example, controls an operation of a fan on the backplane. Generally, the SCU and a service board connected thereto are referred to as an mTCA frame, and a transmission link between the SCU and the service board is an intra-frame transmission link. With an increase of the amount of services, completion of the same service may need cooperation of multiple frames, so a case of cascaded SCUs occurs. SCUs in two frames may be directly connected, which is referred to as self-cascaded SCUs. Due to the limitation of the number of SCU network ports, when SCUs of more than two frames need to be cascaded, the SCUS of the frames may be connected to a lanswitch (Lanswtich, LSW for short) respectively for cascading. A transmission link between SCUs of different frames is an inter-frame transmission link.

In order to ensure reliability of working of the system, two SCUs are generally disposed in each frame, and the two SCUs are connected to a service board respectively, and are connected to an inter-frame transmission link respectively. In providing data packet exchange for the service board, the two SCUs may independently run, and separately provide data packet forwarding for the service board. In system control, one SCU is an active SCU, and the other SCU is a standby SCU, the active SCU performs control, the standby SCU serves as backup hardware, and the active and standby roles of the two SCUs may be switched over, that is, active/standby switching may be performed.

In the system architecture, a requirement for transmission link switching may exist, for example, when active/standby switching is triggered due to a strategy, the active SCU may need to first perform a reset operation, and cannot provide packet transmission for the service board during the resetting period, and at this time, switching needs to be performed so that the standby SCU in the frame provides a transmission link. In the prior art, when an SCU cannot provide packet transmission for the service board because the SCU is in failure, the switching also needs to be performed so that the other SCU in the frame provides a transmission link.

The existing intra-frame and inter-frame Ethernet (Ethernet) data transmission links generally adopt a port trunking (TRUNK) technology to bond physical transmission links provided by the two SCUs into a logic link, that is, a TRUNK group. The two physical transmission links serve as member links of the TRUNK group. Failure detection in the TRUNK technology generally adopts protocols such as the Ethernet operation, administration, and maintenance (Operations, Administration and Maintenance, OAM for short) or the link aggregation control protocol (Link Aggregation Control Protocol, LACP for short). The detection principles are similar. Taking the OAM protocol as an example, each of the SCUs and the service boards send a detection packet via the transmission link at a set detection cycle at an interval, and when no detection packet returned by a peer end is received in a set period of time, it is considered that the transmission link is in failure. As for a transmission link adopting the port trunking technology, a member link in failure may be closed, and the transmitted service data packet is switched to the other member link in the TRUNK group for transmission.

However, in the implementation of the present invention, the inventors find the prior art has the following disadvantages: Based a protocol such as OAM/LACP, a service board is capable of finding that link switching occurs only when no detection packet is received in a set period of time, so a service data packet previously sent by the service board through the transmission link fails to be processed, resulting in a defect of packet loss, thereby decreasing service continuity and reliability.

### SUMMARY OF THE INVENTION

Embodiments of the present invention provide an active/standby switching method, a system control unit, and a communication system, so as to achieve zero—packet—loss link switching of a transmission link in a system in a case of active/standby switching, thereby improving service continuity and reliability.

An embodiment of the present invention provides an active/standby switching method, which includes:

sending, by a first system control unit according to a set detection cycle, a detection packet indicating a transmission link state to a peer network element in a transmission link connected to the first system control unit;

when the first system control unit receives an active/standby switching instruction, stopping sending the detection packet via the transmission link connected to the first system control unit, so that transmission link switching is triggered when the first system control unit stops sending the detection packet in a set timeout period, so as to switch to a transmission link between the peer network element and a second system control unit in a frame for data transmission, and simultaneously starting, by the first system control unit, a switching timer;

when the first system control unit detects that a value of the switching timer reaches a switching timing value, performing, by the first system control unit, a reset operation to complete the active/standby switching, where the switching timing value is greater than the timeout period.

An embodiment of the present invention provides a system control unit, which includes:

a detection packet sending module, configured to send, according to a set detection cycle, a detection packet indicating a transmission link state to a peer network element in a transmission link connected to the system control unit where the detection packet sending module is located;

an active/standby link switching module, configured to, when receiving an active/standby switching instruction, stop sending the detection packet via the transmission link connected to the first system control unit, so that transmission link switching is triggered when the first system control unit stops sending the detection packet in a set timeout period, so as to switch to a transmission link between the peer network element and the other system control unit in a frame for data transmission, and simultaneously start a switching timer for the system control unit where the active/standby link switching module is located; and a reset module, configured to, when it is detected that a value of the switching timer reaches a switching timing value, perform a reset operation of the system control unit where the reset module is located to complete the active/standby switching, wherein the switching timing value is greater than the timeout period.

An embodiment of the present invention further provides a communication system, including one or more frames, each frame includes two system control units and more than one service board, and the system control unit provided by the embodiment of the present invention is used as the system control unit.

According to the active/standby switching method, the system control unit, and the communication system provided by the embodiments of the present invention, before performing the reset operation for the active/standby switching, the SCU first unsolicitedly stops sending the detection packet, but does not immediately perform the reset operation to stop data packet transmission, and delays stopping data packet transmission for a particular duration. The SCU stopping sending the detection packet is equivalent to notifying the peer network element that the transmission link is unavailable, and if no detection packet is sent in the set timeout period, it is judged that the transmission link is in failure, so that transmission link switching is triggered. As the duration of the switching timing value of the SCU is greater than the set timeout period, in the period of time from that SCU stops sending the detection packet to that the transmission link switching is triggered, the SCU does not perform the reset operation, and is still capable of receiving and processing data sent by the peer network element, thereby ensuring the service continuity and reliability.

### BRIEF DESCRIPTION OF THE DRAWINGS

FIG. 1 is a flowchart of an active/standby switching method according to Embodiment 1 of the present invention;

FIG. 2 is a flowchart of an active/standby switching method according to Embodiment 2 of the present invention;

FIG. 3 is a schematic diagram of hardware architecture of a single-frame system in Embodiment 2 of the present invention;

FIG. 4 is a flowchart of an active/standby switching method according to Embodiment 3 of the present invention;

FIG. 5 is a schematic diagram of architecture of a self-cascaded multi-frame system in Embodiment 3 of the present invention;

FIG. 6 is a flowchart of an active/standby switching method according to Embodiment 4 of the present invention;

FIG. 7 is a schematic diagram of architecture of an LSW cascaded multi-frame system in Embodiment 4 of the present invention;

FIG. 8 is a schematic structural diagram of a system control unit according to Embodiment 6 of the present invention; and

FIG. 9 is a schematic structural diagram of a communication system according to Embodiment 7 of the present invention.

### DETAILED DESCRIPTION OF THE EMBODIMENTS

In order to make the objectives, technical solutions, and advantages of the embodiments of the present invention more comprehensible, the technical solutions in the embodiments of the present invention will be clearly and completely described in the following with reference to the accompanying drawings. It is obvious that the embodiments to be described are only a part rather than all of the embodiments of the present invention. All other embodiments obtained by persons skilled in the art based on the embodiments of the present invention without creative efforts shall fall within the protection scope of the present invention.

### Embodiment 1

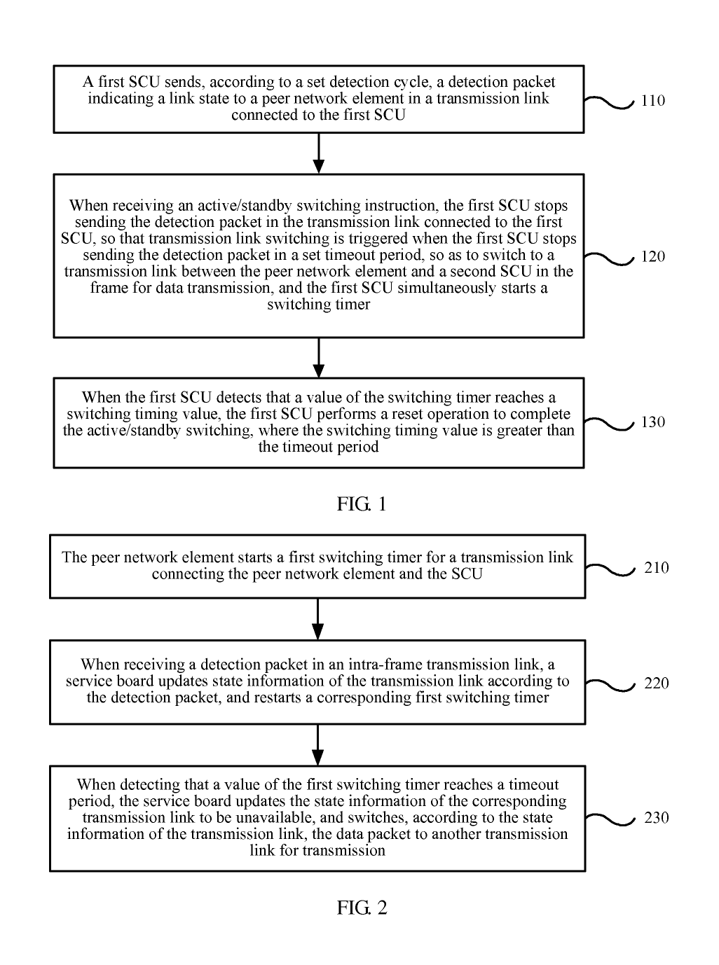

FIG. 1 is a flowchart of an active/standby switching method according to Embodiment 1 of the present invention. This embodiment is specifically applicable in active/standby switching performed in a single-frame or multi-frame communication system formed by SCUs and service boards, and specifically is involved in an operation performed by each of the SCUs. The so-called active/standby switching is one of situations of link switching, and in a practical application, due to failures of some critical modules or strategic needs, an SCU in a frame may be unsolicitedly controlled to perform the active/standby switching, not including a case where an active SCU is directly plugged in or out. In the active/standby switching, the active SCU first stops working, and performs a reset operation. The active/standby switching method of this embodiment specifically includes the following steps:

Step 110: A first SCU sends, according to a set detection cycle, a detection packet indicating a link state to a peer network element in a transmission link connected to the first SCU.

The execution subject first SCU in step 110 may be an active SCU that needs to perform active/standby switching in a frame, and a standby SCU is marked as a second SCU, which also similarly performs the operation of sending a detection packet.

Step 120: When receiving an active/standby switching instruction, the first SCU stops sending the detection packet via the transmission link connected to the first SCU, so that transmission link switching is triggered when the first SCU stops sending the detection packet in a set timeout period, so as to switch to a transmission link between the peer network element and the second SCU in the frame for data transmission, and the first SCU simultaneously starts a switching timer.

The active/standby switching instruction may be input by operating personnel, and may also be transmitted from another device, and instructs the first SCU to perform active/standby switching, that is, the active SCU needs to first stop working and perform a reset operation. At this time, the first SCU unsolicitedly stops sending the detection packet, but not stop data transmission work. Although the SCU has a function of receiving and sending a data packet, as the SCU is ready to enter active/standby switching, the SCU actually does not send the data packet and merely receives a data packet sent by the peer network element.

Step 130: When the first SCU detects that a value of the switching timer reaches a switching timing value, the first SCU performs a reset operation to complete the active/standby switching, where the switching timing value is greater than the timeout period.

According to the technical solution of this embodiment, before performing the reset operation for active/standby switching, the active SCU first unsolicitedly stops sending the detection packet, but not immediately stop data packet transmission, and delays stopping data packet transmission for a particular duration, where a duration of the delay is controlled by the switching timer. The SCU stopping sending the detection packet in the switching timing value, that is, not normally sending the detection packet at least in the timeout period, is equivalent to notifying the peer network element that the transmission link is unavailable, so that the peer network element cannot receive the detection packet according to the set timeout period. In this way, the peer network element is capable of considering, based on an existing link failure detection protocol, for example, the OAM or LACP protocol, that a link failure is detected and thereby triggers link switching by itself. As the duration of the switching timing value is greater than the timeout duration, in the period of delay, the active SCU is still capable of providing a data transmission service for the peer network element till the peer network element detects that the link is unavailable, and stops working after the link is switched by the peer network element. Therefore, the technical solution of this embodiment is capable of reducing the packet loss or achieving zero-packet-loss transmission of service data packets in the situation that active/standby switching is performed, thereby ensuring service continuity and reliability.

The technical solution is described by taking that the active SCU is intended to perform active/standby switching as an example, and in a practical application, if the standby SCU needs to unsolicitedly stop the transmission work, the standby SCU may also perform the preceding operations, that is, first unsolicitedly stops sending a detection packet to notify a peer end, and delay stopping working for a period of time.

In the embodiment, that the transmission link switching is triggered when the first SCU does not send the detection packet in the timeout period, so as to switch to the transmission link between the peer network element and the second SCU in the frame for data transmission, may be specifically implemented in the following manner:

when failing to receive the detection packet sent by the first SCU in the timeout period, the peer network element judges that the transmission link is in failure; and

the peer network element is switched to the transmission link between the peer network element and the second SCU in the frame based on an existing link failure detection protocol for data transmission.

The technical solution is the situation that the peer network element triggers the transmission link switching, and the peer network element may be a service board, or the peer network element may be an SCU in another frame. Detailed illustration is performed below through embodiments.

### Embodiment 2

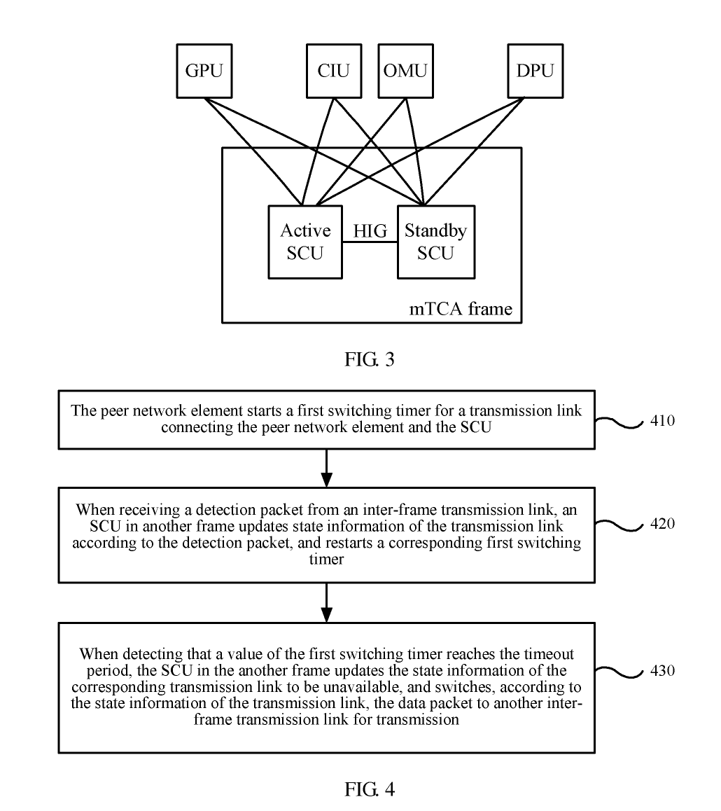

FIG. 2 is a flowchart of an active/standby switching method according to Embodiment 2 of the present invention. This embodiment may be based on the foregoing embodiment, and specifically is a situation that active/standby switching is performed in a single-frame system. FIG. 3 is a schematic diagram of hardware architecture of a single-frame system in Embodiment 2 of the present invention. As shown in FIG. 3, the system has single-mTCA frame architecture, and the frame includes two SCUs that are an active SCU and a standby SCU respectively, and are generally marked as SCU7 and SCU8 according to plugging positions of the SCUs on a backplane. The two SCUs are connected to each service board respectively. In FIG. 3, exemplified service boards are a GPU, a CIU, an OMU, and a DPU. A service board performs packet transmission with the two SCUs through an intra-frame transmission link respectively, the two SCUs are connected through a high-speed link, and preferably a 10 GE port (HiGig, HIG for short) link may be adopted to implement high-speed transmission. The active/standby switching method of this embodiment includes each of the steps performed by the SCU in the foregoing embodiment, and further includes the following steps performed by a peer network element:

Step 210: The peer network element starts a first switching timer for a transmission link connecting the peer network element and the SCU, where in this embodiment, the peer network element is any service board connected to the SCU through an intra-frame transmission link.

Step 220: When receiving a detection packet in the intra-frame transmission link, the service board updates state information of the transmission link according to the detection packet, and restarts a corresponding first switching timer, that is, may clear a timing value of the first switching timer, and enable the first switching timer to start to time again.

Step 230: When detecting that a value of the first switching timer reaches a timeout period, the service board updates the state information of the corresponding transmission link to be unavailable, and switches, according to the state information of the transmission link, the data packet to another transmission link for transmission, where the timeout period is greater than a detection cycle, and is smaller than the switching timing value.

In step 230, when the service board detects that the timeout period is reached, that is, the timer times out, it means that no detection packet is received in the timeout period, and it may be considered that the intra-frame transmission link connected to the SCU is in failure, so that the state information of the transmission link is updated, and the data packet is triggered, according to the state information of the transmission link, to be switched to another transmission link that works normally for transmission. When the service board is switched to a new transmission link to perform data packet transmission, accordingly, an Ethernet port corresponding to the original transmission link that is considered to be in failure may be closed, but preferably, the Ethernet port is set to be available for a receiving side, and unavailable for a receiving side, so as to receive an intransit data packet, thereby avoiding a packet loss.

The reason why the service board fails to receive the detection packet in time may be that the SCU actually is in failure and stops working, and this embodiment of the present invention is applicable in a situation that the SCU needs to perform active/standby switching and unsolicitedly stops sending the detection packet. If the active/standby switching occurs, an intra-frame transmission link between each service board and the SCU fails to receive the detection packet, so each service board may switch the data packet transmission to a transmission link of the other SCU in the frame for transmission. Existing intra-frame and inter-frame Ethernet transmission links generally adopt a TRUNK technology, and multiple physical links are bound into a logic link, so as to form a TRUNK group. As for the active SCU and the standby SCU, a physical link between a service board and the active SCU and a physical link between the service board and the standby SCU are bound into a logic link, and the two physical links both serve as member links of the TRUNK group. In this way, not only a transmission bandwidth is increased, but also data may be simultaneously transmitted through multiple bounded physical links, and when one or more physical links are disconnected due to a failure of the network or another reason, the rest physical links may still work. Through cooperation of a detection result based on the OAM protocol and the TRUNK technology, when it is found that a member link is in failure, data transmission may be switched to the other member link in the TRUNK group, that is, be switched to a transmission link of the standby SCU.

Based on this embodiment, the SCU may correspondingly receive a detection packet sent by a peer network element, that is, a service board, from each transmission link connected to the SCU, and update state information of the transmission link according to whether a detection packet is received and content of a received detection packet; the SCU further synchronizes the state information of the transmission link connected to the SCU to the other SCU in the frame. The two SCUs both perform the synchronization operation, so that the two SCUs are capable of knowing a state of a transmission link of each other. The detection packet sent by the SCU to the service board through the intra-frame transmission link and the correspondingly received detection packet sent by the service board may be implemented based on an existing protocol, for example, based on the OAM protocol compliant with the IEEE802.3ah standard/IEEE802.1ag standard or based on the LACP protocol, states of all point-to-point links in the TRUNK group are detected, and in this case, the detection packet exchanged between the SCU and the service board through the intra-frame transmission link may be an OAM packet or an LACP packet.

In a practical application, after the active SCU and the standby SCU are normally started and work, real-time point-to-point link detection may be set up, and a detection packet is sent according to a set detection cycle, and at the same time, a detection packet returned by the service board is simultaneously received; both the active SCU and the standby SCU know the state of the transmission link according to the detection packet, and synchronize the link state information through a HIG link. When the active SCU receives an active/standby switching instruction and needs to perform a reset operation, the active SCU first stops sending the detection packet, so that the service board is capable of considering the transmission link connected to the active SCU as in failure after a particular period of time and switching to a transmission link of the standby SCU. The active SCU delays stopping working for a period of time after stopping sending the detection packet, and performs a reset operation.

The relationship between the switching timing value, the detection cycle, and the timeout period may be set according to an actual requirement, provided that the switching timing value is greater than the timeout period. Preferably, the detection cycle may be set to 200 ms, the switching timing value may be set to 2 s, and the timeout period may be set to be 600 ms, so that a particular delay margin is able to be retained, thereby ensuring data packet transmission. Setting of durations of the detection cycle and the timeout period may be implemented by changing duration settings in the existing protocol.

### Embodiment 3

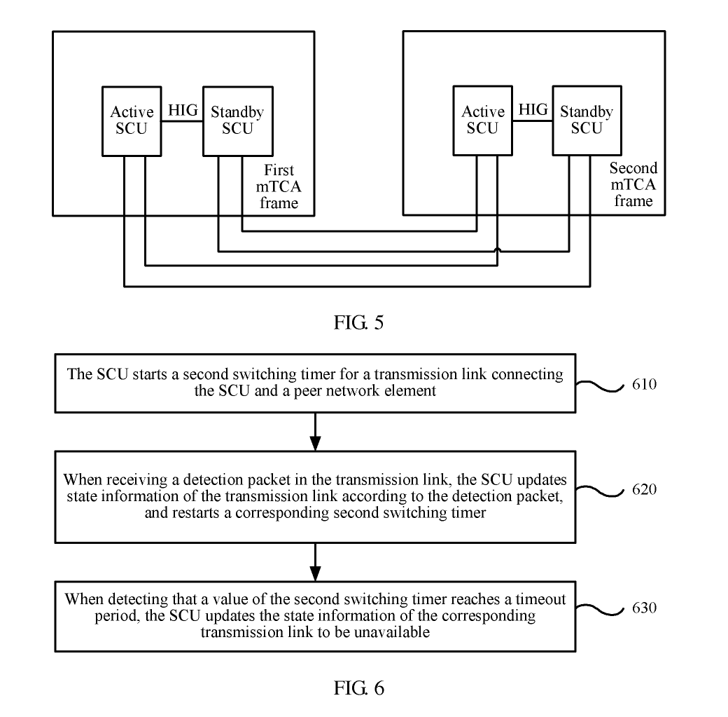

FIG. 4 is a flowchart of an active/standby switching method according to Embodiment 3 of the present invention. This embodiment may be based on the foregoing embodiment, and is specifically applicable in a self-cascaded multi-frame system. FIG. 5 is a schematic diagram of an architecture of a self-cascaded multi-frame system in Embodiment 3 of the present invention. For connection relationships between two SCUs and service boards in each frame, reference may be made to FIG. 3. SCUs of different frames are connected through an inter-frame transmission link as shown in FIG. 5. A manner for detecting a link state of an inter-frame transmission link is consistent with that for detecting a link state of an intra-frame transmission link. The active/standby switching method of this embodiment includes each step performed by the SCU in the foregoing embodiment, and further includes the following steps performed by a peer network element.

Step 410: The peer network element starts a first switching timer for a transmission link connecting the peer network element and the SCU, where in this embodiment, the peer network element is an SCU in another frame connected to the SCU through an inter-frame transmission link, and for the process performed by a service board, reference may be made to the solution in Embodiment 2.

Step 420: When receiving a detection packet from the inter-frame transmission link, the SCU in the another frame updates state information of the transmission link according to the detection packet, and restarts a corresponding first switching timer, that is, may clear a timing value of the first switching timer, and enable the first switching timer to start to time again.

Step 430: When detecting that a value of the first switching timer reaches a timeout period, the SCU in the another frame updates the state information of the corresponding transmission link to be unavailable, and switches, according to the state information of the transmission link, the data packet to another inter-frame transmission link for transmission, where the timeout period is greater than a detection cycle, and is smaller than a switching timing value.

An operation performed by the SCU of the another frame as the peer network element is similar to that performed by the service board, for example, in FIG. 5, when an active SCU and a standby SCU in a second mTCA frame cannot receive a detection packet sent by an active SCU in a first mTCA frame, the data packet is switched to an inter-frame transmission link connected to a standby SCU in the first mTCA frame for transmission.

A detection packet exchanged in an inter-frame transmission link may also be implemented based on the OAM protocol or the LACP protocol, and in this case, the detection packet exchanged between the SCU and the SCU in the another frame through the inter-frame transmission link may be an OAM packet or an LACP packet.

According to the technical solution of this embodiment, in the situation that active/standby switching occurs in a system, it is ensured that no data packet is lost in the inter-frame transmission link. In a practical application, operations performed by each SCU in a frame are the same, and each SCU sends a detection packet and stops sending the detection packet before being required to stop working, and as a peer network element, performs a link switching operation according to the state information of the transmission link when no detection packet is received. As for the link failure detection based on the OAM protocol or the LACP protocol, detection functions set on ports at two sides of the transmission link are the same, so both the service board and the SCU may set the first switching timer to perform timeout control, no matter whether the detection packet is received from the transmission link.

Based on the technical solution of Embodiment 1, that the transmission link switching is triggered when the first SCU does not send the detection packet in the timeout period, so as to switch to the transmission link between the peer network element and the second SCU in the frame for data transmission, may also be implemented in the following manner:

when receiving the detection packet sent by the first SCU, the peer network element returns a detection response;

the first SCU receives, from the transmission link connected to the first SCU, the detection response returned by the peer network element, and updates the state information of the transmission link according to the detection response;

the first SCU synchronizes the state information of the transmission link connected to the first SCU to a second SCU in the frame; and

when the second SCU judges that the transmission link of the first SCU is unavailable according to the synchronously received state information of the transmission link, the second SCU is switched to a transmission link connecting the peer network element and the second SCU for data transmission. This implementation manner is described by taking that a lanswitch serves as a peer network element as an example.

### Embodiment 4

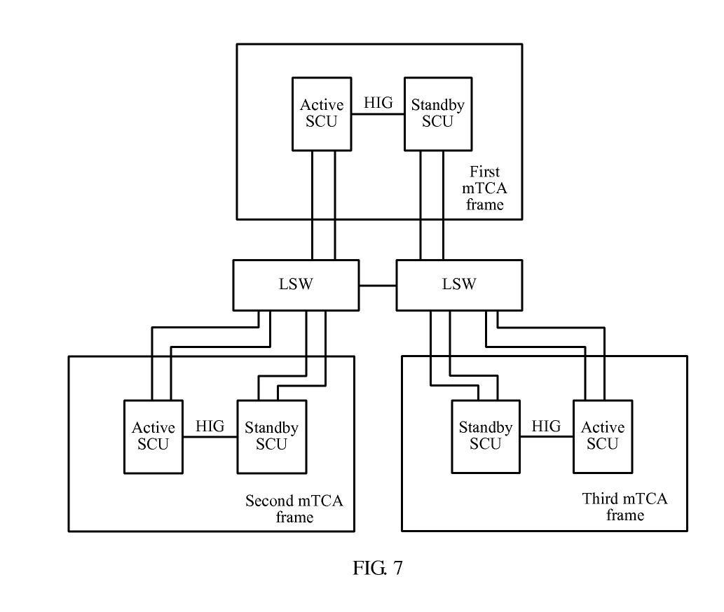

FIG. 6 is a flowchart of an active/standby switching method according to Embodiment 4 of the present invention. This embodiment may be based on the foregoing embodiment, and is specifically applicable in an LSW cascaded multi-frame system. Due to a limitation of the number of network ports on an SCU panel, in some large-traffic scenarios, more than three mTCA frames need to be cascaded for cooperation, so an external LSW needs to be introduced for implementing concatenation, and manners in which all the frames are connected to the LSW are the same. FIG. 7 is a schematic diagram of architecture of an LSW cascaded multi-frame system in Embodiment 4 of the present invention. For a connection relationship between two SCUs and service boards in a frame, reference may be made to FIG. 3. A connection between SCUs of different frames is shown in FIG. 7. SCUs in each frame are all connected to the LSW, and two LSWs are connected to each other through an inter-frame transmission link. The active/standby switching method of this embodiment includes the steps performed by the SCU in the foregoing embodiment, and the operation that the SCU receives a detection packet sent by a peer network element from each transmission link connected to the SCU, and updates state information of the transmission link according to the detection packet may specifically include the following steps:

Step 610: The SCU respectively starts a second switching timer for each transmission link connecting the SCU and a peer network element, where an operation of the SCU is applied to a peer network element being a service board, an SCU in another frame in a self-cascading scenario, or an LSW.

Step 620: When receiving a detection packet in a transmission link, the SCU updates state information of the transmission link according to the detection packet, and restarts a corresponding second switching timer, that is, may clear a timing value of the second switching timer, and enable the second switching timer to start to time again.

Step 630: When the SCU detects that a value of the second switching timer reaches a timeout period, that is, the second switching timer times out, the SCU updates the state information of the corresponding transmission link to be unavailable, where the timeout period is greater than a detection cycle, and is smaller than a switching timing value.

Thereafter, the SCU may continuously perform a synchronization operation of the state information.

Limited by a requirement of real-time service link detection, a standard OAM cannot be adopted between the LSW and the SCU to detect the link state. Therefore, an access control list (Access Control List, ACL for short) function universal for LSW ports is enabled to perform link detection, so that an LSW port receives a packet of a specified type, and directly returns the packet to the SCU, and the SCU sends the packet of the specified type. The LSW returning the packet of the specified type to the SCU is equivalent to returning a detection response to the SCU. The processing process of the SCU side on the packet of the specified type is similar to the processing manner based on the OAM protocol, and link state information may be obtained from the packet, thereby indirectly completing detection of the link between the SCU and the LSM. At the same time, the SCU notifies the other SCU in the frame of the detected link state information through a HIG link.

As the SCUs in each frame are not directly connected to receive and send the detection packet, but cascaded through an LSW, different from a self-cascaded link switching manner, in the LSW cascaded manner, the SCU in the frame where active/standby switching occurs unsolicitedly completes link switching. That is, when the peer network element in this embodiment is an LSW connected to a first SCU through an inter-frame transmission link, after the first SCU synchronizes state information of a transmission link connected to the first SCU to a second SCU in the frame, the method further includes: judging, by the second SCU in the frame, whether a transmission link of the first SCU of a peer board is unavailable according to the synchronously received state information of each transmission link, and if the transmission link of the first SCU of the peer board is unavailable, the second SCU switches a data packet exchanged between the first SCU of the peer board and the LSW to a transmission link connecting between the LSW and the second SCU for data transmission.

Take the structure shown in FIG. 7 as an example. After starting to work, an active SCU and a standby SCU in a first mTCA frame both send a detection packet according to a set detection cycle; and meanwhile, each of the SCUs also detects whether a detection response is able to be received in the timeout period. When no detection response is received after the timeout period, it is judged that the link is in failure, the link state information is updated, and the other SCU in the frame is notified. The other SCU may perform link switching according to a link state of the active SCU. When receiving an active/standby switching instruction, the active SCU in the first mTCA frame stops sending the detection packet to the LSW. In this case, the LSW does not return a detection response, and thereby the active SCU in the first frame is capable of detecting that the timeout period is exceeded and judge that the link is in failure.

In this embodiment, the SCU that needs to perform active/standby switching unsolicitedly performs link switching, but the condition for triggering the link switching is the same as that for the SCU of another frame that does not perform active/standby switching in Embodiment 3, that is, if no detection packet is received in a particular period of time, link switching is triggered. Therefore, the timeout period of the service board and the SCU may be set to different durations, and may also be set to the same duration.

### Embodiment 5

An active/standby switching method provided in Embodiment 5 of the present invention may be based on any one of the foregoing embodiments, and preferably, state information of a transmission link in an exchanged detection packet includes physical layer state information and link layer state information. In this case, a step that a service board or a second SCU triggers transmission link switching according to the state information of the transmission link, so as to switch to a transmission link between a peer network element and the second SCU in the frame for data transmission, may specifically perform the following operations: Determine whether a state of each transmission link is available according to the physical layer state information and the link layer state information of the transmission link and a set link selection strategy. As for SCUs, each SCU not only performs link selection according to information about a transmission link connected to the SCU, but also may perform link selection according to synchronously obtained link state information of a peer board SCU. A transmission link to be switched is selected from transmission links with states being available, and a data packet is switched to the selected transmission link for transmission.

In a practical application, ports at two sides of an intra-frame transmission link corresponding to an active SCU may be marked as GE1 ports, and ports at two sides of an inter-frame transmission link may be marked as GE3 ports; ports at two sides of an intra-frame transmission link corresponding to a standby SCU may be marked as GE2 ports, and ports at two sides of an inter-frame transmission link may be marked as GE4 ports. A state of a transmission link is known by exchanging a detection packet between an SCU and a service board, between cascaded SCUs, and between an SCU and an LSW. In addition, the link state information is correspondingly recorded in a local board. The state information of the transmission link preferably includes physical layer state information and link layer state information, where the physical layer state information may be expressed as link up (Link up) and link down (Link down), and the link layer state information may be expressed as normal and in failure. According to the physical layer state information, the link layer state information, and the set link selection strategy, it is determined whether a state of a transmission link is available, and a transmission link to be switched to is selected from transmission links with states being available.

The set link selection strategy may be set according to a requirement, and preferably the determining whether a transmission link to be selected is available according to the physical layer state information and the link layer state information of the transmission link and the set link selection strategy specifically include:

determining a state of a transmission link with link layer state information being normal to be available, because when the link layer state is normal, the physical layer state is definitely link up; and when it is judged that the link layer state information of each transmission link is in failure, determining a state of a transmission link with physical layer state information being link up to be available.

A relationship between the physical layer state information, the link layer state information, and transmission link availability is the link selection strategy, and as for an inter-frame transmission link of a service board, one specific manner is listed in Table 1.

TABLE 1

| GE1 Port | GE2 Port | GE1 Port | | |
|---|---|---|---|---|
| Physical | Physical | Link | GE2 Port | |
| Layer | Layer | Layer | Link Layer | Link Selection |
| State | State | State | State | Strategy |
| Link up | Link up | Normal | Normal | GE1 is available, GE2 |
| | | | | is available |
| Link up | Link up | Normal | In failure | GE1 is available, GE2 |
| | | | | is unavailable |
| Link up | Link up | In failure | Normal | GE1 is unavailable, |
| | | | | GE2 is available |
| Link up | Link up | In failure | In failure | GE1 is available, GE2 |
| | | | | is available |
| Link up | Link down | In failure | In failure | GE1 is available, GE2 |
| | | | | is unavailable |
| Link down | Link up | In failure | In failure | GE1 is unavailable, |
| | | | | GE2 is available |
| Link down | Link down | In failure | In failure | GE1 is unavailable, |
| | | | | GE2 is unavailable |

Based on the preceding link selection strategy, first, whether a transmission link is available is determined according to the link layer state; when all link layer states are in failure, whether a transmission link is available is determined according to the physical layer state, where a transmission link with the physical layer state being link up is available.

As for an SCU, a link selection strategy for an intra-frame transmission link and an inter-frame transmission link is similar to that for a service board. First, whether a transmission link is available is determined according to the link layer state; and when all the link layer states are in failure, whether a transmission link is available is determined according to the physical layer state, where a transmission link with the physical layer state being link up is available. A corresponding relationship of transmission link states formed by the link selection strategy is shown in Table 2.

TABLE 2

| GE1 Port | GE2 port | GE3 Port | GE4 Port | GE1 Port | GE2 Port | GE3 Port | GE4 Port | |
|---|---|---|---|---|---|---|---|---|
| Physical | Physical | Physical | Physical | Link | Link | Link | Link | Link |
| Layer | Layer | Layer | Layer | Layer | Layer | Layer | Layer | Selection |
| State | State | State | State | State | State | State | State | Strategy |
| Link up | Link up | Link up | Link up | Normal | Normal | Normal | Normal | All are |
| | | | | | | | | available |
| Link up | Link up | Link up | Link up | In | In | Normal | Normal | GE1 is |
| | | | | failure | failure | | | unavailable, |
| | | | | | | | | GE2, GE3, |
| | | | | | | | | and GE4 are |
| | | | | | | | | available |
| Link up | Link up | Link up | Link up | In | In | In | In | All are |
| | | | | failure | failure | failure | failure | available |
| Link | Link up | Link up | Link up | In | In | In | In | GE1 is |
| down | | | | failure | failure | failure | failure | unavailable, |
| | | | | | | | | GE2, GE3, |
| | | | | | | | | and GE4 are |
| | | | | | | | | available |

### Embodiment 6

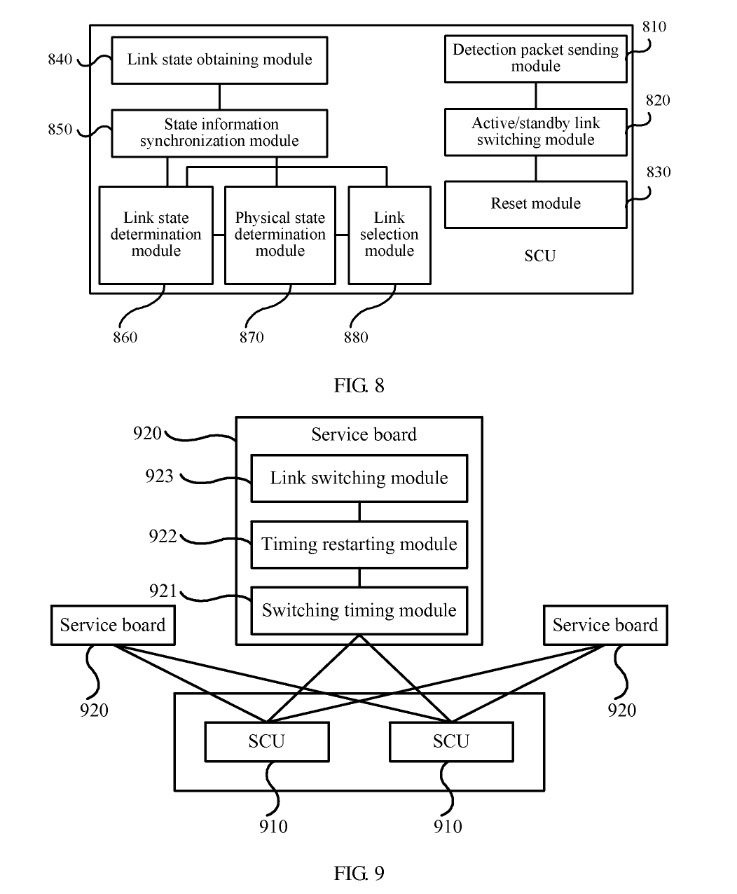

FIG. 8 is a schematic structural diagram of a system control unit according to Embodiment 6 of the present invention. The SCU may be an active SCU or a standby SCU, and may also be any SCU in a single frame or multiple frames. The SCU includes a detection packet sending module 810, an active/standby link switching module 820, and a reset module 830. The detection packet sending module 810 is configured to send, according to a set detection cycle, a detection packet indicating a transmission link state to a peer network element in a transmission link connected to the SCU where detection packet sending module 810 is located. The active/standby link switching module 820 is configured to, when receiving an active/standby switching instruction, stop sending the detection packet via the transmission link connected to the SCU, so that transmission link switching is triggered when the SCU stops sending the detection packet in a set timeout period, so as to switch to a transmission link between the peer network element and the other SCU in a frame for data transmission, and simultaneously start a switching timer for the SCU where the active/standby link switching module 820 is located. The reset module 830 is configured to, when it is detected that a value of the switching timer reaches a switching timing value, perform a reset operation of the SCU where the reset module 830 is located to complete the active/standby switching, where the switching timing value is greater than the timeout period.

According to the technical solution of this embodiment, before performing the reset operation for active/standby switching, a first SCU, that is, an active SCU, first unsolicitedly stops sending the detection packet, but does not immediately stop data packet transmission, and delays stopping data packet transmission for a particular duration. The SCU stopping sending the detection packet is equivalent to notifying the peer network element that the transmission link is unavailable, so that the peer network element cannot receive a detection packet in the timeout period and thereby considers that a link failure is detected, which triggers the transmission link switching. As the duration of the switching timing value is greater than the timeout period, in the period of time for delay, the active SCU is still capable of providing a data transmission service for the peer network element, and does not stop working until the peer network element switches the link. Therefore, the technical solution of this embodiment is capable of achieving zero-packet-loss transmission of data packets in a situation that the active/standby switching is performed, thereby ensuring service continuity and reliability.

Based on the technical solution, in this embodiment, the SCU is preferably set to further include: a link state obtaining module 840 and a state information synchronization module 850. The link state obtaining module 840 is configured to receive, from the transmission link connected to the SCU where the link state obtaining module 840 is located, a detection response returned, according to the detection packet, by the peer network element, and update state information of the transmission link according to the detection response. The state information synchronization module 850 is configured to mutually synchronize the state information of a connected transmission link with the other SCU in the frame.

The link state obtaining module may specifically include: a switching timing unit, a first state updating unit, and a second state updating unit. The switching timing unit is configured to start a second switching timer for a transmission link connecting the SCU and the peer network element. The first state updating unit is configured to, when a detection packet or a detection response is received in the transmission link, update the state information of the transmission link according to the detection packet or the detection response, and restart a corresponding second switching timer. The second state updating unit is configured to, when it is detected that a value of the second switching timer reaches the timeout period, update the state information of the corresponding transmission link to be unavailable, where the timeout period is greater than the detection cycle, and is smaller than the switching timing value.

The state information is synchronized between two SCUs in each frame, which facilitates controlling the link switching by the SCU. The SCU may also include a link switching module, configured to, when it is judged that a transmission link of the other SCU is unavailable according to the synchronously received state information of the transmission link, switch data transmission between the other SCU and the peer network element to the transmission link connected to the SCU where the link switching module is located. This solution is applicable in the situation that the other SCU is intended to perform active/standby switching, where the SCU may unsolicitedly initiate the transmission link switching, as described in the foregoing embodiments, and especially applicable in the situation that cascading is performed through a lanswitch.

Preferably, the state information of the transmission link in the detection packet includes physical layer state information and link layer state information, the SCU may further include: a link state determination module 860, a physical state determination module 870, and a link selection module 880. The link state determination module 860 and the physical state determination module 870 cooperate with the state information synchronization module 850, and are configured to determine whether a state of each transmission link is available according to the physical layer state information and the link layer state information of the transmission link and a set link selection strategy, and not only perform link selection according to information about transmission links connected to themselves, but also may perform link selection according to synchronously obtained link state information of a peer board SCU. Specifically, the link state determination module 860 is configured to, when it is judged that a transmission link with the link layer state being normal exists according to the link layer state information, determine a state of the transmission link with the link layer state information being normal to be available. The physical state determination module 870 is configured to, when it is judged that link layer state information of all transmission links is in failure according to the link layer state information, judge a physical layer state of a transmission link according to the physical layer state information, and determine a transmission link with the physical layer state being link up to be available. The link selection module 880 is configured to select a transmission link to be switched to from transmission links with states being available, and switch to the selected transmission link for data transmission.

The SCU provided by each of the embodiments of the present invention may perform the active/standby switching methods provided by this embodiments of the present invention, so as to achieve zero—packet—loss link switching in active/standby switching, thereby ensuring continuity and reliability of service transmission.

### Embodiment 7

FIG. 9 is a schematic structural diagram of a communication system according to Embodiment 7 of the present invention. The system includes one or more frames, each frame includes two SCUs 910 and more than one service board 920. FIG. 9 shows architecture with one frame. The system adopts the SCU provided by any embodiment of the present invention as the SCU 910.

The service board 920 preferably includes a switching timing module 921, a timing restarting module 922, and a link switching module 923. The switching timing module 921 is configured to start, respectively, a first switching timer for transmission links connecting the service board 920 and the SCUs 910. The timing restarting module 922 is configured to, when the service board 920 receives a detection packet in a transmission link, update state information of the transmission link according to the detection packet, and restart a corresponding first switching timer. The link switching module 923 is configured to, when it is detected that a value of the first switching timer reaches a timeout period, update the state information of the corresponding transmission link to be unavailable, and switch, according to the state information of the transmission link, a data packet to another transmission link for transmission, where the timeout period is greater than a detection cycle, and is smaller than a switching timing value.

According to the technical solution in each of the embodiments of the present invention, real-time link detection may be set up between the SCU and a peer service board, another peer SCU, or a peer LSW to ensure the reliability of the current link transmission. When the active SCU needs to perform active/standby switching due to a failure of a critical module or a strategic requirement, the active SCU board stops sending a detection packet in all relevant intra-frame/inter-frame transmission links to start a delayed reset of a timer. During this period, the interconnected service board/SCU board detects that the relevant link times out and is in failure, and all services are switched to another transmission link with the link state being normal, thereby ensuring zero—packet—loss data transmission, that is, an upper layer does not sense the whole switching process.

Persons of ordinary skill in the art should understand that all or a part of the steps of the methods according to the embodiments of the present invention may be implemented by a program instructing relevant hardware. The program may be stored in a computer readable storage medium. When the program is run, the steps of the methods according to the embodiments of the present invention are performed. The storage medium may be any medium that is capable of storing program codes, such as a ROM, a RAM, a magnetic disk, and an optical disk.

Finally, it should be noted that the preceding embodiments are merely provided for describing the technical solutions of the present invention, but not intended to limit the present invention. It should be understood by persons of ordinary skill in the art that although the present invention has been described in detail with reference to the embodiments, modifications may be made to the technical solutions described in the embodiments, or equivalent replacements may be made to some technical features in the technical solutions, as long as such modifications or replacements do not depart from the spirit and scope of the present invention.

What is claimed is:

1. An active/standby switching method, comprising:
sending, by a first system control unit, according to a set detection cycle, a detection packet to a peer network element via a transmission link connected between the first system control unit and the peer network element, wherein the detection packet is used for indicating a transmission link state, wherein the first system control unit is in a frame;
when the first system control unit receives an active/standby switching instruction, stopping sending the detection packet via the transmission link connected between the first system control unit and the peer network element, so that transmission link switching is triggered when the first system control unit stops sending the detection packet in a set timeout period, so as to switch to a transmission link between the peer network element and a second system control unit in the frame for data transmission, and simultaneously starting, by the first system control unit, a switching timer; and
when the first system control unit detects that a value of the switching timer reaches a switching timing value, performing, by the first system control unit, a reset operation to complete the active/standby switching, wherein the switching timing value is greater than the timeout period.

2. The active/standby switching method according to claim 1, wherein the triggering the transmission link switching when the first system control unit stops sending the detection packet in the timeout period, so as to switch to the transmission link between the peer network element and a second system control unit in the frame for data transmission, comprises:
judging, by the peer network element, that the transmission link is in failure when receiving no detection packet sent by the first system control unit in the timeout period; and
switching, by the peer network element, from the transmission link between the peer network element and the first system control unit to a transmission link between the peer network element and the second system control unit in the frame for data transmission based on a link failure detection protocol.

3. The active/standby switching method according to claim 2, wherein
a detection packet exchanged between the first system control unit and a service board through an intra-frame transmission link is an OAM packet or a LACP packet.

4. The active/standby switching method according to claim 2, wherein
a detection packet exchanged between the first system control unit and a system control unit in another frame through an inter-frame transmission link is an OAM packets or a LACP packet.

5. The active/standby switching method according to claim 1, wherein the triggering the transmission link switching when the first system control unit stops sending the detection packet in the timeout period, so as to switch to the transmission link between the peer network element and the second system control unit in the frame for data transmission, comprises:
returning, by the peer network element, a detection response when receiving the detection packet sent by the first system control unit;
receiving, by the first system control unit, from the transmission link connected between the first system control unit and the peer network element, the detection response returned by the peer network element, and updating state information of the transmission link connected between the first system control unit and the peer network element according to the detection response;
synchronizing, by the first system control unit, the state information of the transmission link connected between the first system control unit and the peer network element to the second system control unit in the frame; and
when the second system control unit judges that the transmission link the transmission link connected between the first system control unit and the peer network element is unavailable according to the synchronously received state information of the transmission link connected between the first system control unit and the peer network element, switching, by the second system control unit, from the transmission link between the peer network element and the first system control unit to a transmission link between the peer network element and the second system control unit in the frame for data transmission.

6. The active/standby switching method according to claim 1, wherein the detection cycle is 200 ms, the switching timing value is 2 s, and the timeout period is 600 ms.

7. The active/standby switching method according to claim 1, wherein the state information of the transmission link comprises physical layer state information and link layer state information, and the triggering the transmission link switching, so as to switch to the transmission link between the peer network element and the second system control unit in the frame for data transmission, comprises:
when it is judged that a transmission link with a link layer state being normal exists according to the link layer state information, determining a state of the transmission link with the link layer state information being normal to be available;
when it is judged that link layer state information of each transmission link is in failure according to the link layer state information, judging a physical layer state of a transmission link according to the physical layer state information, and determining a state of a transmission link with a physical layer state being link up to be available; and
selecting a transmission link to be switched to from transmission links with states being available, and switching the data transmission to the selected transmission link.

8. A system control unit, wherein the system control unit is in a frame, comprising:
a detection packet sending module, configured to send, according to a set detection cycle, a detection packet to a peer network element via a transmission link connected between the system control unit where the detection packet sending module is located and the peer network element, wherein the detection packet is used for indicating a transmission link state;
an active/standby link switching module, configured to, when receiving an active/standby switching instruction, stop sending the detection packet via the transmission link connected between the system control unit and the peer network element, so that transmission link switching is triggered when the system control unit stops sending the detection packet in a set timeout period, so as to switch from the transmission link connected between the system control unit and the peer network element to a transmission link connected between another system control unit in the frame and the peer network element for data transmission, and simultaneously start a switching timer for the system control unit where the active/standby link switching module is located; and
a reset module, configured to, when it is detected that a value of the switching timer reaches a switching timing value, perform a reset operation on the system control unit where the reset module is located to complete active/standby switching, wherein the switching timing value is greater than the timeout period.

9. The system control unit according to claim 8, further comprising:
a link state obtaining module, configured to receive, via the transmission link connected between the system control unit and the peer network element, a detection response, wherein the detection response is returned by the peer network element according to the detection packet, and to update state information of the transmission link connected between the system control unit and the peer network element according to the detection response; and
a state information synchronization module, configured to synchronize the state information of the transmission link connected between the system control unit and the peer network element with another system control unit in the frame.

10. The system control unit according to claim 9, further comprising:
a link switching module, configured to, when it is judged that a transmission link of connected between another system control unit and the peer network element is unavailable according to synchronously received state information of the transmission link connected between the another system control unit and the peer network element, switch data transmission connected between the another system control unit and the peer network element to the transmission link connected between the system control unit where the link switching module is located and the peer network element.

11. The system control unit according to claim 9, wherein the state information of the transmission link comprises physical layer state information and link layer state information, and the system control unit further comprises:
a link state determination module, configured to, when it is judged that a transmission link with a link layer state being normal exists according to the link layer state information, determine a state of the transmission link with the link layer state information being normal to be available;
a physical state determination module, configured to, when it is judged that link layer state information of each transmission link is in failure according to the link layer state information, judge a physical layer state of a transmission link according to the physical layer state information, and determine a state of a transmission link with a physical layer state being link up to be available; and
a link selection module, configured to select a transmission link to be switched to from transmission links with states being available, and switch to the selected transmission link for data transmission.

12. A communication system, comprising one or more frames, wherein each frame comprises a first system control unit and a second system control unit and more than one service board, and
the first system control unit is configured to send, according to a set detection cycle, a detection packet to a peer network element via a transmission link connected between the first system control unit and the peer network element, wherein the detection packet is used for indicating a transmission link state, and stop sending the detection packet via the transmission link connected between the first system control unit and the peer network element when receiving an active/standby switching instruction, so that transmission link switching is triggered when the first system control unit stops sending the detection packet in a set timeout period, so as to switch to a transmission link between the peer network element and a second system control unit in the frame for data transmission, and is further configured to simultaneously start a switching timer; and when detecting that a value of the switching timer reaches a switching timing value, perform a reset operation to complete the active/standby switching, wherein the switching timing value is greater than the timeout period.

13. The system according to claim 12, wherein a peer network element is the service board, a system control unit in another frame or a Lanswtich, LSW; and
the peer network element is configured to judge that the transmission link is in failure when receiving no detection packet sent by the first system control unit in the timeout period; and switch from the transmission link between the peer network element and the first system control unit to a transmission link between the peer network element and the second system control unit in the frame for data transmission based on a link failure detection protocol;

14. The system according to claim 12, wherein a peer network element is the service board, a system control unit in another frame or a Lanswtich, LSW; and
the peer network element is configured to return a detection response when receiving the detection packet sent by the first system control unit;
the first system control unit is further configured to receive, from the transmission link connected between the first system control unit and the peer network element, the detection response returned by the peer network element, update state information of the transmission link connected between the first system control unit and the peer network element according to the detection response; and synchronize, the state information of the transmission link connected between the first system control unit and the peer network element to the second system control unit in the frame; and
the second system control unit is configured to judge that the transmission link the transmission link connected between the first system control unit and the peer network element is unavailable according to the synchronously received state information of the transmission link connected between the first system control unit and the peer network element, and switch from the transmission link between the peer network element and the first system control unit to a transmission link between the peer network element and the second system control unit in the frame for data transmission.

15. A no-transitory computer-readable medium having computer executable instructions for performing a method comprising:
sending, by a first system control unit, according to a set detection cycle, a detection packet to a peer network element via a transmission link connected between the first system control unit and the peer network element, wherein the detection packet is used for indicating a transmission link state, wherein the first system control unit is in a frame;
when the first system control unit receives an active/standby switching instruction, stopping sending the detection packet via the transmission link connected between the first system control unit and the peer network element, so that transmission link switching is triggered when the first system control unit stops sending the detection packet in a set timeout period, so as to switch to a transmission link between the peer network element and a second system control unit in the frame for data transmission, and simultaneously starting, by the first system control unit, a switching timer; and
when the first system control unit detects that a value of the switching timer reaches a switching timing value, performing, by the first system control unit, a reset operation to complete the active/standby switching, wherein the switching timing value is greater than the timeout period.
